(19) United States
(12) Patent Application Publication
(10) Pub. No.: US 2003/0231926 A1
(43) Pub. Date: Dec. 18, 2003

(54) Tubing coupler

(75) Inventor: Ngoc Minh Thach, La Verne, CA (US)

Correspondence Address: Koda & Androlia, Suite 3850, 2029 Century Park East, Los Angeles, CA, 90067, US

(73) Assignee: Santana Cycles, Inc.

(21) Appl. No.: 10/171,119

(22) Filed: Jun. 13, 2002

(51) Int. Cl. F16L 23/00

(52) U.S. Cl. 403/339

(57) ABSTRACT

A coupler for detachably connecting two separate pieces of tubing including first and second parts wherein each of the first and second parts have a base portion and a coupling portion. The base portion is for coupling to two respective pieces of tubing and the coupling portion is substantially in the same of a Z when viewed from the side.

### BACKGROUND OF THE INVENTION

1. Field of the Invention

The present invention relates to tubing couplers and more particularly relates to tubing couplers for detachably connecting two pieces of tubing in a rigid manner.

2. Prior Art

In prior art, there exists several means for coupling together two pieces of tubing or pipe. Such couplers include providing the two pieces of tubing or pipe with male and female threads and screwing them together, providing an exterior coupling piece which fits over both ends of the two pieces of pipe or providing adaptors whereby the pieces of pipe or tubing can be bolted together. While all of these prior devices provide the general purpose of coupling together two pieces of pipe or tubing, all of them contain disadvantages.

The main disadvantage of the prior art tubing or pipe couplers is that they are necessarily round. Another disadvantage is that to achieve an acceptable degree of structural integrity, male and female joints of prior art tubing or pipe couplers have a larger diameter than the tubing or pipe as well as long extension, adding significant weight to the tubing or pipe.

Examples of the above-described prior art tubing or pipe couplings can be found in U.S. Pat. Nos. 6,379,074; 6,209,926; and 4,067,534.

### SUMMARY OF THE INVENTION

Accordingly, it is a general object of the present invention to overcome the disadvantages of the prior art.

In particular, it is a general object of the present invention to provide a coupling for two pieces of tubing or pipe which are not exclusively round.

It is another object of the present invention to provide a coupler that achieves uniformity with the outer diameter of two pieces of tubing or pipe.

It is still another object of the present invention to provide a coupler for tubing or pipe which provides easy means for coupling together the two pieces of tubing or pipe.

It is still another object of the present invention to provide a coupler that is light in weight and reasonably easy to manufacture.

In keeping with principles of the present invention, the objects are accomplished by a coupler for detachably connecting together two separate pieces of tubing or pipe. The coupler comprises first and second portions which each comprises first and second portions consisting of a base portion and a coupling portion. The base portion is of an outer size and shape substantially equal to an inner cross-section of the tubing or pipe and is for being coupled to the inner surface of the tubing or pipe. The coupling portion is of an outer size and shape substantially equal to an outer cross-sectional shape of the tubing. The coupler portion further comprises three surfaces wherein first and second of the three surfaces extend partially across the entire outer cross-sectional shape of the tubing from opposite sides, are displaced in a longitudinal direction of the tubing and are substantially parallel to each other and a third surface of the three surfaces connects the first and second surfaces together and is an angle to both the first and second surfaces. The three surfaces form a shape substantially equal to a “Z” when viewed from the side. To complete the coupling, the three surfaces of the coupling portion of each of the first and second members are engaged together and a bolt is provided transversely through the first and second members. With such a construction, a rigid coupling between the two separate pieces of tubing can be achieved.

With this design, the coupler is very compact, rigid and uniform with the outer diameter of the tubing or pipe. The use of this design would not be limited by round tubing or pipe, but could be incorporated into other tubing or pipe profiles including, but not limited to, oval, square, rectangular and hexagonal.

### BRIEF DESCRIPTION OF THE DRAWINGS

The above-mentioned features and objects of the present invention will become more apparent from the following description, taken in conjunction with the accompanying drawings wherein like reference numerals denote like elements and in which:

FIG. 1 is a side view of the coupling of the present invention utilized to couple together two separate pieces of pipe;

FIG. 2 is perspective view of a first member of the coupler of the present invention;

FIG. 3 is a side view of a first member of a coupler of the present invention;

FIG. 4 is a rear view of a first member of a coupler in accordance with the teachings of the present invention;

FIG. 5 is a top view of a first member of a coupler in accordance with the teachings of the present invention;

FIG. 6 is a perspective view of a second member of a coupler of the present invention;

FIG. 7 is side view of a second member of a coupler in accordance with the teachings of the present invention;.

FIG. 8 is a rear view of a second member of a coupler in accordance with the teachings of the present invention; and

FIG. 9 is a top view of a second member of a coupler in accordance with the teachings of the present invention.

### DETAILED DESCRIPTION OF THE INVENTION

Referring to FIG. 1, shown therein is a coupler 2 for coupling together two separate pieces of tubing (shown in dotted line) 4 and 6. The coupler 2 comprises first and second members 8 and 10. The first and second members 8 and 10 each comprises a base portion 12 and 14, respectively, and coupling portions 16 and 18, respectively. The base portions 12 and 14 are respectively fixed to the two separate pieces of tubing 4 and 6, respectively, by means of conventional methods which is compatible with the materials of the coupler Z and the tubing 4 and 6 such as welding, soldering, adhesives, etc. In addition, a bolt 20 (shown in dashed lines) extends transversely of the coupling 2 through a hole provided in the second member into a threaded portion provided in the first member 16 so that the first and second members 8 and 10 can be held together.

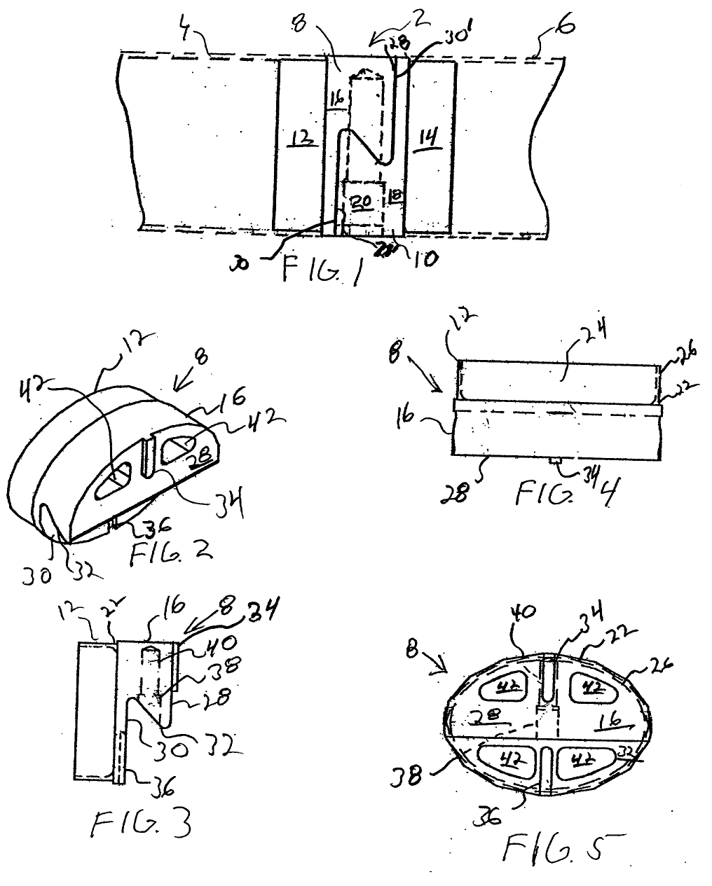

While the above generally describes the coupler 2 of the present invention, referring to FIGS. 2-5, shown therein are the first member 8. The first member 8 in turn comprises a base portion 12 and a coupling portion 16. The first member can be made of any material which provides sufficient strength, is sufficiently workable and is compatible with the material from which the tubing 4 and 6 is made and the method of affixing the base 12 to the inner surface of the tubing 4. Such materials include various plastic such as vinyl, polypropylene, acrylics, etc. and metals such as aluminum, steel, brass, copper, alloys thereof, etc.

The base portion 12 is of substantially the same shape and size as the inner cross-section of the tubing 4 and is therefore smaller in size than the outer shape of the coupling portion 16. As a result, there is a step or flange 22 between the base portion 12 and the coupling portion 16. The interior 24 of the base portion 12 could be solid, but in the interest of reducing the weight is made hollow and accordingly the base portion 12 has side wall 26 which is of sufficient thickness to provide the required stiffness.

The coupling portion 16 of the first member 8 includes three surfaces in addition to its outer circumferential surface. The three surfaces comprise the top surface 28, the bottom surface 30 and the connecting surface 32. Each of the top and bottom surfaces extend partially across the entire outer cross-section of the tubing from opposite sides and are substantially parallel. The third surface 32 is at an angle to both the top and bottom surfaces 28 and 30 and would be typically at an angle of substantially 45° to the bottom surface 30 and a negative 45° relative to the top surface 28.

The top surface 28 is further provided with a key 34 and the bottom surface 30 is provided with a key way 36.

The coupling member 16 is further provided with a transverse stepped hole 38 which is provided with a threaded portion 40. This hole 38 and threaded portion 40 are provided for the bolt 20 for coupling together the first and second members. In addition and so as to lighten the first member 8, lightening holes 42 are provided in the first member. These lightening holes 42 extend through the top and bottom surfaces 28 and 30; however, in the interest of maintaining stiffness and rigidity, it is preferable that these holes 42 not reduce the surface area of the top and bottom surfaces 28 and 30 by more than 50%.

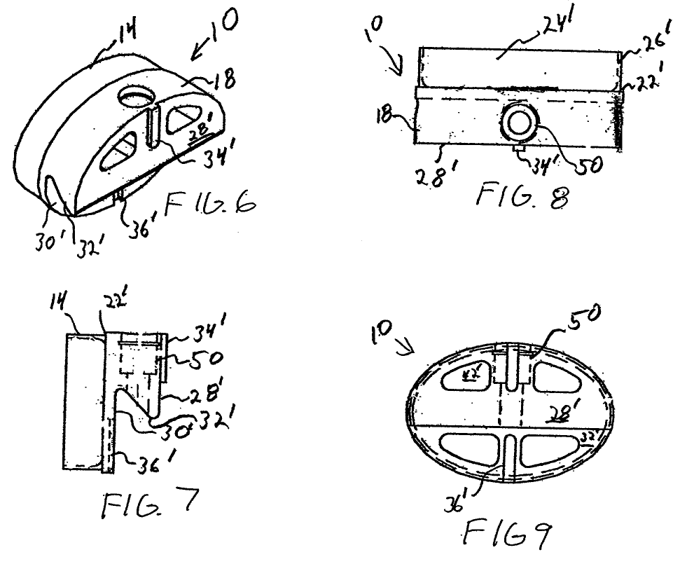

Referring to FIGS. 6-9 shown therein are the second member 10. The second member 10 generally comprises a base portion 14 and a coupling portion 18. In addition, the second member 10 is substantially made the same way as the first member 8. As a result, elements of the second member 10 which are substantially the same as the elements of the first member 8 are given the same reference numeral with the addition of an apostrophe.

In addition, the second member 10 is provided with a stepped hole 50 into which is inserted a bolt 20 for fixing the first and second members together.

In operation and as discussed above, the first and second members are installed or fixed to the respective tubing pieces 4 and 6 by any suitable means such as welding, soldering or adhesive. Then the first and second members 8 and 10 are fitted together so that the top surface 28 of first member 8 engages with the bottom surface 30′ of the second member 10. Similarly, bottom surface 30 of the first member 8 engages with the top surface 28′ of the second member 10. In addition, the key 34 of the first member 8 fits into the key way 36′ of the second member 10 and the key 34′ of the second member 10 fits into the key way 36 of the first member 8. A bolt 20 is then inserted into stepped hole 50 in the second member 10 and threaded into the threaded portion 40 of the stepped hole 38 in the first member 8 and tightened down. In this way, a solid, stable and stiff connection is provided between the pipe pieces 4 and 6.

While the present invention is described in terms of the specific embodiments set forth above, it should apparent to those skilled in the art that other varied arrangements could be provided which would still be within the scope of the present invention. Such variations would include the fact that the coupling can be of any cross-sectional shape which matches the cross-section of the pipe or tubing; and while it is shown as elliptical, it could be square, rectangular, circular, octagonal, etc. In addition and to make the coupling even more stiff, it would also be possible to shape the keys 34 and 34′ such that they are wider at the top than at the bottom and to correspondingly shape the key ways 36 and 36′ such that they too are wider at the bottom and narrower at the top.

I claim:

1. A coupler for detachably connecting together two separate pieces of tubing, said coupler comprising first and second members with each of said first and second members comprising a base portion and a coupling portion wherein:
said base portion is of an outer size and shape substantially equal to an inner cross-section of the tubing and for being coupled to the inner surface of the tubing; and
said coupling portion is of an outer size and shape substantially equal to an outer cross-section of the tubing, said coupler portion further compriseing three surfaces wherein first and second of said three surfaces extend partially across said entire outer cross-section of said coupler from opposite sides, are displaced in a longitudinal direction of said tubing and are substantially parallel to each other and a third surface of said three surfaces connects said first and second surfaces together and is an angle to both said first and second surfaces wherein said three surfaces form a shape substantially equal to a “Z” when viewed from the side;
whereby rigid coupling between two separate pieces of tubing can be provided.

2. The coupler according to claim 1 further comprising a transverse hole provided substantially through said first and second members with the portion of said hole in said second member being threaded and a bolt inserted into said transverse hole and threaded into said threaded portion of said hole in said first member.

3. The coupler according to claim 2 further comprising corresponding keys and key ways provided in both said first and second member which engage together.

4. The coupler according to claim 2 wherein said base and coupling portions are integrally formed.

5. The coupler according to claim 3 wherein said base and coupling portions are integrally formed.

6. The coupler according to claim 4 wherein said base and coupling portions are made of steel.

7. The coupler according to claim 5 wherein said base and coupling portions are made of steel.

8. The coupler according to claim 1 wherein said cross-section of said tubing is selected from the group consisting of oval, square, rectangular and hexagonal.

9. The coupler according to claim 2 wherein said cross-section of said tubing is selected from the group consisting of oval, square, rectangular and hexagonal.

10. The coupler according to claim 3 wherein said cross-section of said tubing is selected from the group consisting of oval, square, rectangular and hexagonal.

11. The coupler according to claim 4 wherein said cross-section of said tubing is selected from the group consisting of oval, square, rectangular and hexagonal.

12. The coupler according to claim 5 wherein said cross-section of said tubing is selected from the group consisting of oval, square, rectangular and hexagonal.
